(19) United States
(12) Patent Application Publication
(10) Pub. No.: US 2015/0356265 A1
(43) Pub. Date: Dec. 10, 2015

(54) HEALTHCARE MANAGEMENT SYSTEM AND METHOD

(71) Applicant: Han S. Chiu, La Jolla, CA (US)

(72) Inventor: Han S. Chiu, La Jolla, CA (US)

(21) Appl. No.: 14/698,797

(22) Filed: Apr. 28, 2015

Related U.S. Application Data
(60) Provisional application No. 61/985,435, filed on Apr. 28, 2014.

(51) Int. Cl. G06F 19/00

(52) U.S. Cl. CPC G06F 19/3425; G06F 19/3418

(57) ABSTRACT

A system for providing a community in which treatments may be tested for conditions associated with one or more entities. Information may be received that includes a condition of an entity, the condition associated with a particular domain, and one or more symptoms of the condition experienced by the entity. Access to the information may be provided to one or more domain experts. The provision of one or more treatments for the condition to the community may be facilitated. The treatment of the condition may be tracked and analyzed for efficacy. Treatment plans may be suggested for conditions based on the analysis of the information provided to the community.

### CROSS-REFERENCE TO RELATED APPLICATION

This application claims the benefit of and priority to, under 35 U.S.C. §119(e), U.S. Provisional Application No. 61/985,435, filed Apr. 28, 2014 which is incorporated herein by reference in its entirety.

### BACKGROUND

Many critically important data points that could affect consumer goods, medical products, and virtually any industry that produces products for consumers don't reach the appropriate thought leading experts or even mid-level experts in time for them to be acted upon until other tragic events occur. These tragedies can include deaths, injuries, or simply the absence of a better way of taking care of an important need.

The best example of this effect is in the medical industry where consumers are patients, mid-level experts are community doctors, and thought leaders are academic physicians.

While there are many examples where the failure of early detection of data points could have led to the more timely removal of a product prior to mass lawsuits, death, and other injury, there are also just as many cases where better therapies that should be in the market never make it.

Even some of the therapies that do make it to market, often do so without validation for the primary application for which such therapies have the greatest utility or do not cover other interesting applications. Nowhere does this happen more frequently than with therapies that are curative or preventative in nature.

This is because a cure or prevention has no recurring revenue stream and so is less profitable than a chronic therapy. Moreover such therapies may be a threat to revenue streams of successful chronic products. These are usually produced by companies with significant resources and who are in a position to thwart the development of such-treatments. Many of these therapies flounder and in the process do not get successfully patented forcing them to enter the public domain. Others begin as approaches or technologies that are already in the public domain, but in either case more often than not curative and preventative technologies and/or processes are not protectable by patents. When protection is available it is often not of the strength afforded to most biotechnologies and pharmaceuticals. This creates a vicious cycle where these therapies never attract the attention they need to reach the mainstream. Examples of technologies that fall into this category include Acupuncture, Yoga, Meditation and many other alternative care practices.

In essence non patentable therapies and many curative and preventative therapies are not entering the development arena at the same level as more profitable patentable chronic therapies are.

### SUMMARY

The present disclosure relates to providing a process that can be implemented to facilitate the low cost and efficient gathering of data that can be channeled from initial information providers, such as consumers and community health professionals, to domain experts, such as mid-level experts and thought leaders. This process may channel such information in such a meaningful way that a positive study or change can be implemented in in response to the domain experts determining treatments based on the information provided to them through the presently disclosed systems and methods.

The present disclosure uses the example of the medical field to describe one or more implementations of the presently disclosed subject matter. This is not intending to be limiting. The presently disclosed subject matter relates to gathering and/or receiving information about the condition of entities, where those conditions have symptoms, providing that information in an innovative manner to domain experts, and facilitating the creation of treatments for those conditions. Information may relate to conditions in any field, not just the medical field.

The presently disclosed subject matter describes novel systems and processes that facilitate the generation of data to support the development of therapies. The same novel systems and processes can be applied for early detection of adverse effects and alternative applications of existing therapies that might otherwise not get studied. The approach can be used in other industries outside of medicine.

The present disclosure is relates to facilitating a Web-directed “big data” capture of data, and providing that data to domain experts, such as top thought leaders and mid-level experts. In the example of the healthcare industry, information may be received from doctors and patients and can be used to prove the effectiveness of treatments.

One aspect of the present disclosure relates to a web-based community. The web-based community may be provided by a computer implemented method performed using one or more physical computer processors. Information may be received over a network, such as the Internet, to a community host. The community host may be a server that is connected to the Internet. The information may include an indication of a condition of an entity, the condition associated with a particular domain, and one or more symptoms of the condition experienced by the entity. Access to the information may be provided to one or more domain experts. The one or more domain experts may access the information over the network. The community may facilitate the one or more domain experts to provide treatment plans for the conditions.

In some implementations, the one or more treatment plans may be tracked and analyzed for efficacy at treating the condition. Such analysis may include the determination of one or more side effects to the treatments experienced by the entity.

In some implementations, one or more treatment plans for the conditions may be determined by the one or more computer processors executing computer program instructions. The treatment plans may be determined based on correlations appearing in the information.

Correlations may be determined between the one or more created treatments for the condition and the one or more symptoms association with the condition. The information associated with other conditions may be accessed; the information may include symptom information of the other conditions. A suggestion of treatments may be generated for the other conditions based on the correlations determined between the one or more created treatments and the one or more symptoms.

The information may be received through crowd sourcing the information. This may be facilitated over the Internet. The information may be provided from one or more treatment providers, such as physicians.

The received information may be filtered to remove non-salient information from the information store.

The community may validate the treatments of the condition of the entity based on the analysis of the efficacy of the treatments. A notification may be generated for delivery to domain experts that include an indication of the validated treatment.

In some implementations, the community may generate a web-accessible information page. The web-accessible information pay may provide an indication of at least, the validated treatments, associated conditions, associated symptoms, or associated side effects.

The presently disclosed methods and systems provide novel ways to have patients and doctors drive the innovation process. Such systems and method may be referred to as a reverse clinical trial process where instead of industry driving the process, physicians and patients do. The information obtained by the presently disclosed subject matter may relate to millions of patients and thousands of doctors, allowing for a greater pool of data compared to typical clinical trials. Typical clinical trials may involve only thousands of patients and tens of doctors. Furthermore, the presently disclosed subject matter will facilitate the identification of trends and negate the necessity for the overly restrictive manner in which present clinical trials are performed. Present clinical trials are often so restrictive that trials often have very little bearing on what real patients are like. The presently disclosed subject matter will provide studies encompassing all persons using a particular treatment and therefore will provide truly meaningful data from which to make clinical decisions.

The presently disclosed subject matter may include simplifying the data received about the condition of an entity, such as from a patient or doctor. The data may be simplified to only include the salient data. Such a process may be automated. Consequently, the collection of the initial information may be facilitated through the Internet and through crowd sourcing technologies. The system may facilitate one or more administrators or domain experts to edit the information. The information may be edited based on direction from domain experts, such as top academic centers.

The presently disclosed subject matter provides ways to strengthen the relationship between consumers of products, mid-level experts, and thought leaders by working bi-directionally, in an organic manner.

The presently disclosed subject matter also provides a way to use consumer information and domain expert information to generate viable models for the treatment of conditions of entities. This may be done in a way that attracts the attention of thought leaders in the domain. In some implementations, thought leaders may seed the presently disclosed information depository with some of their models in an attempt to gain interest and validation from consumers and midlevel experts.

In response to a determination that one or more treatments is viable and that a treatment is well documented and supported by consumers and mid-level experts, the thought leaders may be notified of the treatment. This gives the thought leaders an opportunity to implement a top down study of the already supported treatment protocol for the condition of the entity. Such study may refine the needs of the treatment and then utilize the network, developed in large part from crowd sourcing, to provide a new treatment or protocol to patients through the presently disclosed system. The new treatment may be rolled out in a controlled manner (i.e. there is both a control and test arm).

The presently disclosed subject matter may include a web-based data portal that can become a clearinghouse for therapies and serve as a gateway for therapies to reach consumers.

One a treatment has been validated a web-accessible information page, such as a Wikipedia-like reference, may be generated. The web-accessible information page may provide information from which a practitioner or patient can learn the rationale for a therapy, the identity of the providers of the therapy, and the reasons for providing the therapy.

The information repository may be used to gather efficacy and safety information associated with various treatments that has been provided by practitioners and patients. This information may be used to identify treatments that are appropriate for commercialization, protection through intellectual property protection and/or other processes.

The presently disclosed systems and methods may be configured to continuously track the administration of such generated therapies, and previously generated therapies. The system may facilitate collaboration and information sharing associated with the results of the offered therapies.

The details of one or more embodiments are set forth in the accompanying drawings and the description below. Other features and advantages will be apparent from the description and drawings, and from the claims.

### BRIEF DESCRIPTION OF THE DRAWINGS

FIGS. 1-10 provide illustrations of the interactions between an information-providing entity and other stakeholders in determining treatments for conditions of entities, using a system having one or more features consistent with aspects of the presently disclosed subject matter;

FIG. 11 is an illustration of a review process for a proposed treatment study implemented by a system having one or more features consistent with aspects of the presently disclosed subject matter;

FIG. 12 is an illustration of requirements for conducting a treatment study implemented by a system having one or more features consistent with aspects of the presently disclosed subject matter;

FIGS. 13-16 are illustrations of decision trees associated with proposed treatment studies implemented by a system having one or more features consistent with aspects of the presently disclosed subject matter;

FIG. 17 is an illustration of relationships between events and advantages of using a system having one or more features consistent with aspects of the presently disclosed subject matter; and,

FIG. 18 is an illustration of a system having one or more features consistent with aspects of the presently disclosed subject matter.

These and other aspects will now be described in detail with reference to the following drawings.

### DETAILED DESCRIPTION

Although a few embodiments have been described in detail above, other modifications are possible. Other embodiments may be within the scope of the following claims.

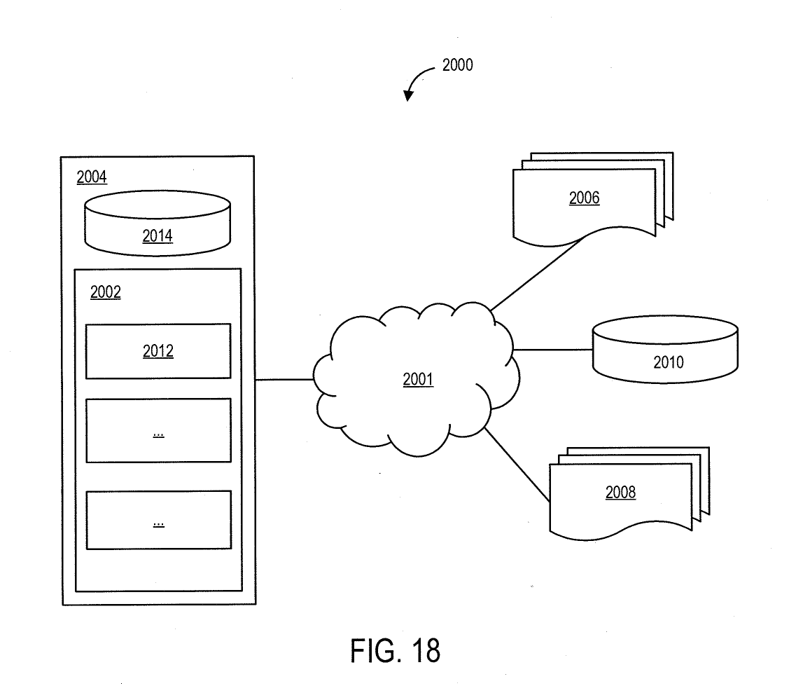

FIG. 18 illustrates a system 2000 configured to facilitate the collaboration and information sharing between various stakeholders connected with the treatment of conditions. The system 2000 may comprise one or more physical processors 2002. The system may include communication lines between various elements of the system to enable the exchange of information with a network and/or other computing platforms. Such communication lines may include a network 2001. The network 2001 may be, for example, the Internet. The processors 2002 may be configured to execute computer program instructions. The processors 2002 may be configured to execute the computer program instructions via one or more of hardware, software, and/or firmware. Although system 2000 may be described in certain sections herein as including a single server 2004, this is not intended to be limiting. The functionality attributable to server 2004 may be attributable to multiple servers and/or other components of system 2000. The functionality attributable to server 2004 may be performed by a series of interconnected home computers. At least some of the functionality herein described may be performed by client computing devices 2006, third-party computing devices 2008, third-party electronic storage providers 2010, and/or other computer devices.

A given client computing device 2006 may include one or more processors configured to execute computer program instructions. The computer program instructions may be configured to enable an expert or user associated with the given client computing device 2006 to interface with system 200 and/or external resources 2008, third-party storage devices 2010, and/or provide other functionality attributed herein to client computing device 2006. By way of non-limiting example, the given client computing platform 2006 may include one or more of a desktop computer, a laptop computer, a handheld computer, a tablet computing device, a NetBook, a Smartphone, a gaming console, a client-side server and/or other computing devises.

The processor (s) 2002 may be configured to execute computer program instructions, such as computer program instructions 2012. Computer program instructions 2012 are represented here as discrete blocks within processor 2002, but this is not intended to be limiting. The discrete blocks for computer program instructions 2012 is provided in FIG. 18 for ease of representation only, and the present disclosure contemplates any format or arrangement of computer program instructions 2012. The functionality described herein may be provided by discrete computer program modules and/or components, or may be provided by continuous uninterrupted code, or by any other arrangement of computer program instructions. The computer program instructions 2012 may be stored in electronic storage media. The computer program instructions 2012 may be stored in electronic storage media 2014 associated with server 2004 in which at least one or more of the processors 2002 reside. The computer program instructions 2012 may be stored in external storage 2010. In some of the implementations, the computer program instructions 2012 for providing a client portal to clients may be stored on client computing devices 106 associated with the clients.

The external resources 2008 may include sources of information, cross-referencing services, fact checking services and/or other services that are provided by external entities participating with system 2000, and/or other resources. In some implementations, some or all of the functionality attributed herein to external resources 2008 may be provided by resources included in system 2000.

Electronic storage 2014 and/or electronic storage 2010 may comprise electronic storage media that electronically stores information. The electronic storage media of electronic storage 2014 may include one or both of system storage that is provided integrally (i.e., substantially non-removable) with server 2004 and/or removable storage that is removably connectable to server 2004 via, for example, a port (e.g., a USB port, a firewire port, etc.) or a drive (e.g., a disk drive, etc.). Electronic storage 2014 may be associated with client computing devices 10. Electronic storage 2010/2014 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storage 2010/2014 may include one or more virtual storage resources (e.g., cloud storage, a virtual private network, and/or other virtual storage resources). Electronic storage 2010/2014 may store software algorithms, information determined by processor 2002, information received from server 2004, information received from client computing devices 2006, information received from external resources 2008 and/or other information that enables server 2004 to function as described herein.

Processor(s) 2002 is configured to provide information processing capabilities in server 2000. As such, processor 2002 may include one or more of a digital processor, an analog processor, a digital circuit designed to process information, an analog circuit designed to process information, a state machine, and/or other mechanisms for electronically processing information. Although processor 2002 is shown in FIG. 18 as a single entity, this is for illustrative purposes only. In some implementations, processor 2002 may include a plurality of processing units. These processing units may be physically located within the same device, or processor 2002 may represent processing functionality of a plurality of devices operating in coordination.

The server 2004 may be configured to receive information. The information may contain an indication of a condition of an entity. The information may contain symptoms of the entity associated with that condition. The condition may be an undesirable condition. The information may be submitted to server 2004 through communication lines. The communication lines may include a network 2001, such as the Internet. Users, such as consumers, and mid-level experts, may use client computing devices 2006 to provide the information to the server 2004 over the Internet 2001. In some implementations a graphical user interface may be generated by the server 2004. The graphical user interface may be implemented on client computing devices 2006, the data for which being sent over the network 2001.

The information may be stored on electronic storage media 2014 associated with the server 2004. The information may be arranged on a database in electronic storage media 2014. In some implementations the information may be stored on electronic storage media 2010. Access to the data may be through a network 2001, such as the Internet. When such storage is used it may be referred to as “cloud storage.”

In some implementations, the information received may relate to health conditions of people and may include symptoms experienced by people having those conditions. The information may be provided by the people themselves, their healthcare provider, or insurance companies associated with the provision of healthcare. In some implementations the information may be provided by merging an information repository with the information database contained in electronic storage 2010. In some implementations, the information may be contained in multiple locations, and provided by multiple providers, such as external providers 2008.

The server 2004 may be configured to provide access to the received information to consumers, providers of product, and domain experts. In the medical field these entities may be patients, doctors, and thought leaders. The information may accessed by any of the entities through client computing devices 2006.

The server 2004 may be configured to receive information associated with the treatment of the condition. The treatment information may be provided by the consumer themselves, or may be provided by the providers of the product and/or domain experts. In some implementation, a treatment may be provided by an external source 2008.

The system 2000 may be configured to track the one or more treatments for the condition. In some implementations, each entity may have an individual entity ID in a database. The individual entity ID may be associated with conditions and symptoms reported by any one of the reporters of information. The reports of information may update an entry in the database associated with an individual entity, such as a patient, this information may be analyzed to track the effectiveness of a treatment on conditions experienced by the entity.

The system 2000 may be configured to analyze the one or more treatments for its efficacy at treating the condition. The one or more treatments may cause side effects for the entity. The system 2000 may be configured to analyze the one or more treatments for a condition across multiple entities. The system 2000 may be configured to provide a statistical analysis of the effectiveness of the treatment for a particular condition experienced by multiple entities.

The system 2000 may be configured to facilitate the determination of one or more treatments for the condition by the one or more domain experts. The system may be configured to detect patterns across the information that is provided to it and see connections between elements of the data. These connections may be provided to domain experts who may use those connections to develop treatments for conditions.

In some implementations, the system 2000 may be configured to determine correlations between the one or more created treatments for the condition and the one or more symptoms association with the condition. The system 2000 may be configured to access information associated with other conditions where that information includes symptom information of the other conditions. The system 2000 may generate a suggestion of treatments for the other conditions based on the correlations determined between the one or more created treatments and the one or more symptoms. In this manner the system 2000 may be able to automatically, or with the assistance of domain experts, determine treatment for conditions of entities, where those treatments may have been previously unknown.

The system may be configured to filter the received information. Non-salient information may be filtered out of the received information to simply the information provided to the system.

The treatments reported for the conditions may be validated based on the analysis of the efficacy of the treatments. The system 2000 may generate a notification for delivery to domain experts of the validated treatment.

The system 2000 may be configured to generate a web-accessible information page. The web-accessible information pay may provide an indication of at least, the validated treatments, associated conditions, associated symptoms, or associated side effects. The server 2004 may be configured to host the web-accessible information page. In some implementations, the system 2000 may case a web-server to host the web-accessible information page that is logically and/or physically separate from server 2004 that is providing the information repository and database management.

The presently disclosed subject matter facilitates strengthening and leveraging of the relationships between domain experts, mid-level experts, product providers, and consumers. Studies on treatments for conditions may be proposed through the presently disclosed system. The presently disclosed system may facilitate the creation of a community where the community collaborates in proposing, performing, and evaluating the outcome of a study.

In the case of healthcare, consumers are patients, mid-level experts are community doctors, and thought leaders are academic physicians. Leverage is created, because each academic physician influences perhaps hundreds of community doctors. Each community doctor influences thousands of patients.

A study may be proposed through a public web site. The information captured may include:
a. Basic demographic information on the patient
   i. Age
   ii. Sex
   iii. Race
   iv. Weight
   v. Height
b. Basic areas of interest for which the patient would wish to be notified for a private or public treatment protocol

The presently disclosed systems and methods may use crowd sourcing observations with regard to the effects of potential technologies such as medical technologies. The presently disclosed systems and methods may monitor potential impact and utility of such technologies. All of the information may be provided to a Big Data framework where it can be studied and documented for patterns and where combined intuition, computing and brain power of the larger community can be applied to assembling the insights and knowledge.

The information may be obtained from multiple different entities. For example:
a. Consumers or in the medical field patients
b. Mid-level field experts which in the medical field are known as community doctors
c. Thought leading field experts which in the medical field are known as thought leaders from top academic and medical institutions
d. Companies of interest, but while they may enhance the original data file they need to get consumers, mid-level experts and thought leaders to support the idea.

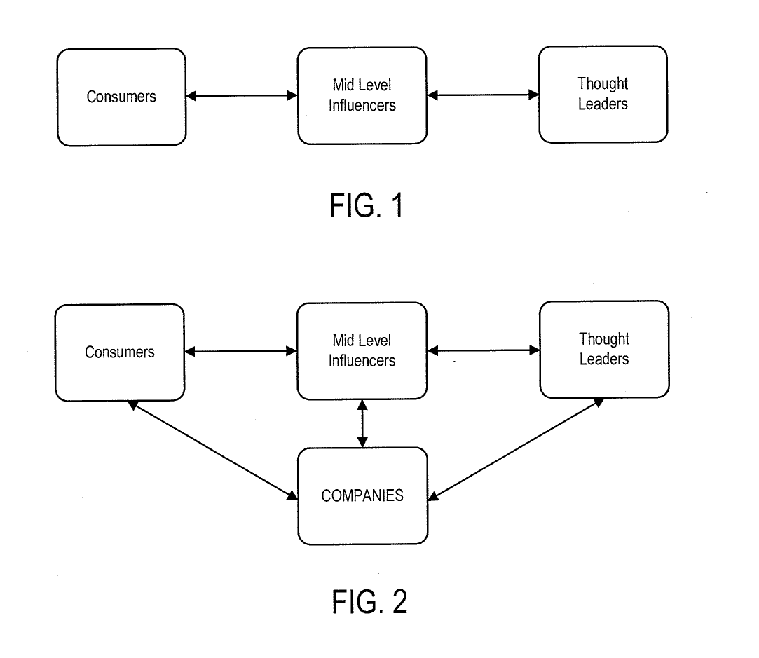

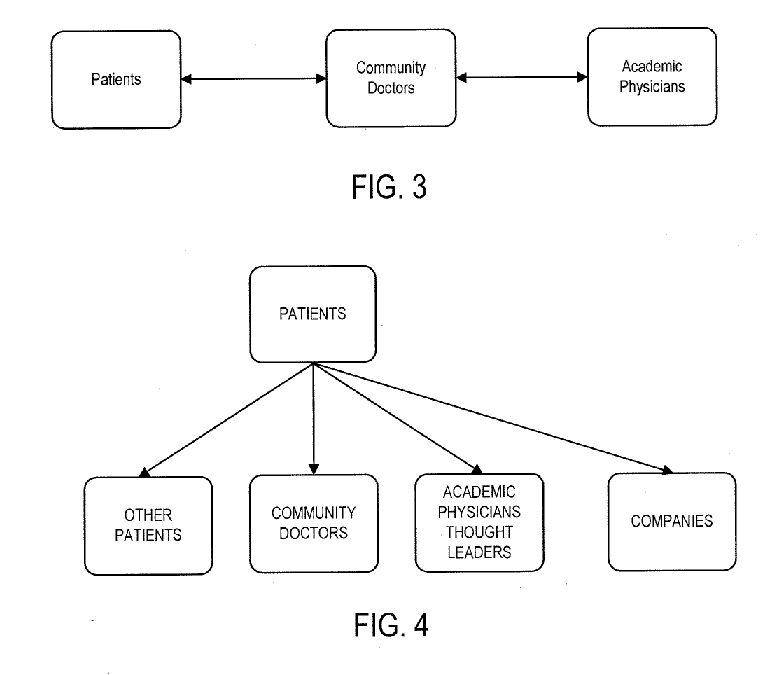

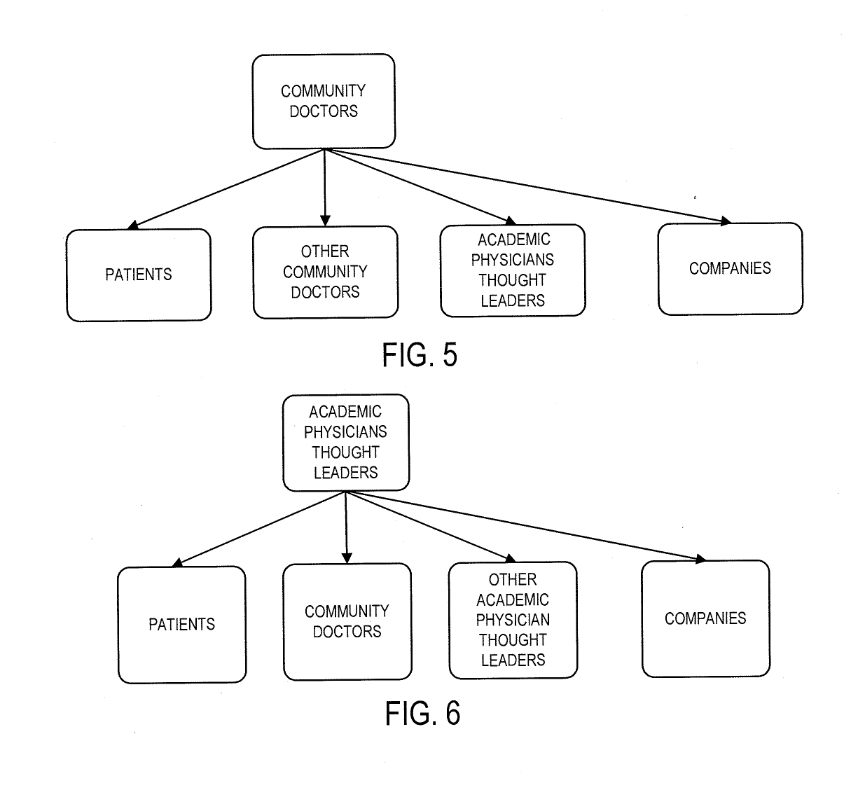

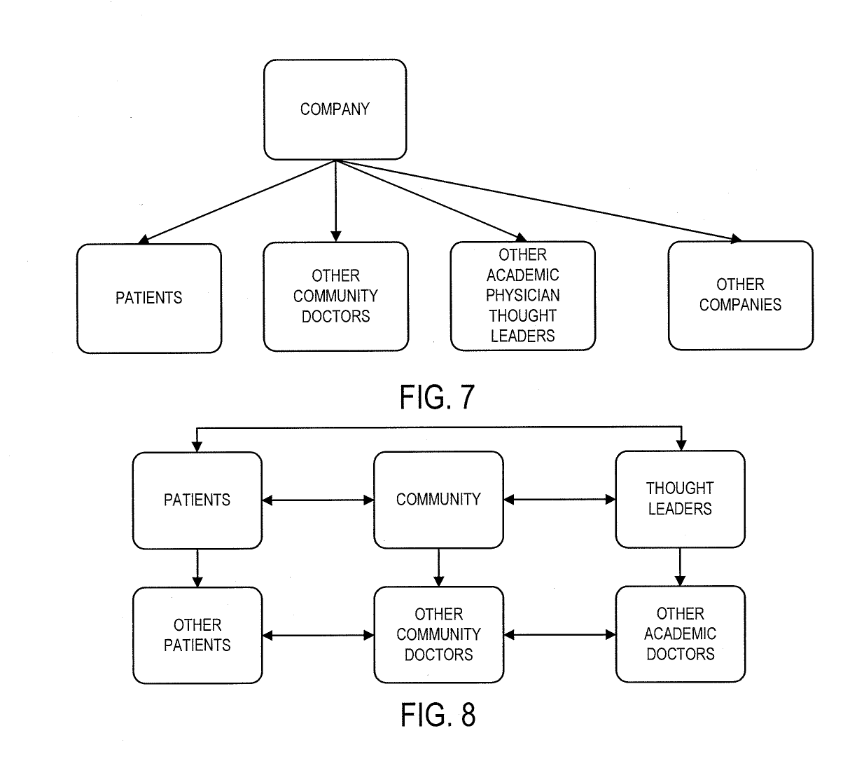

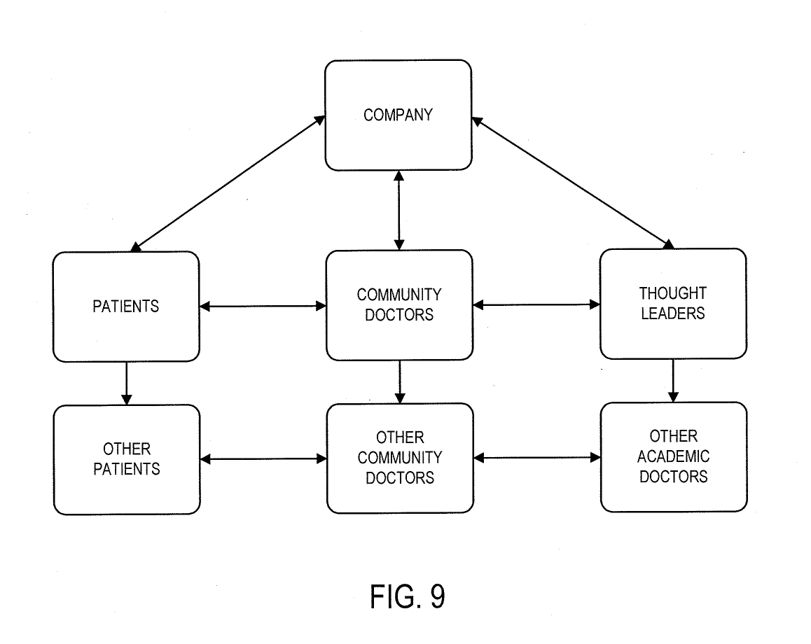

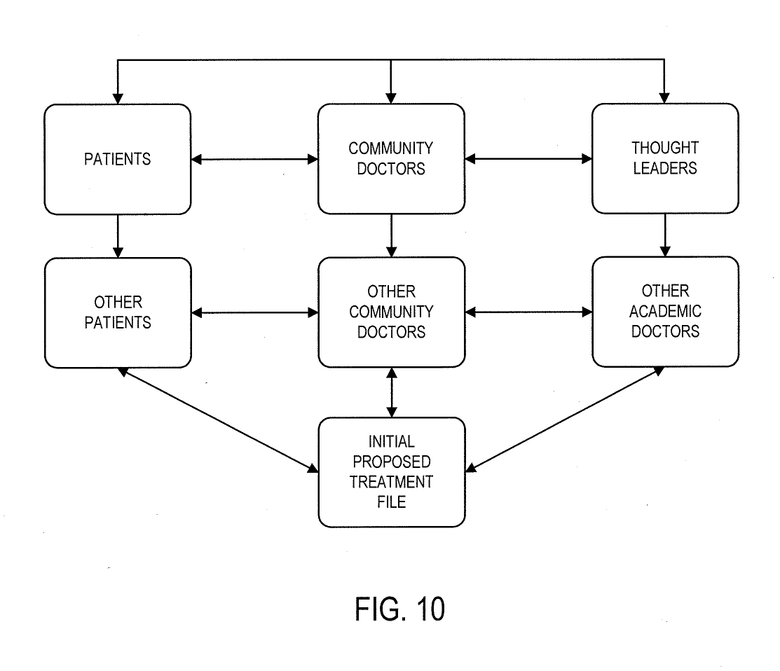

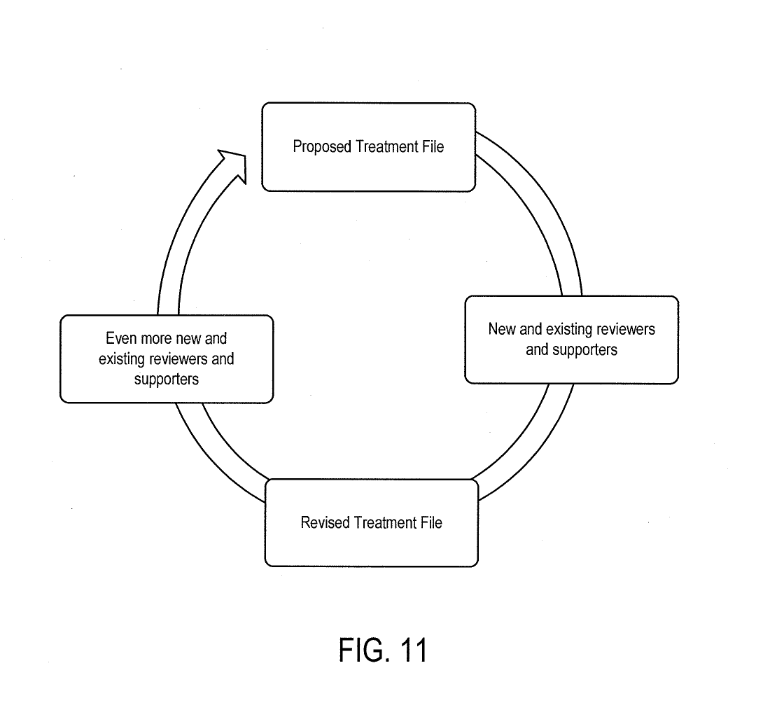

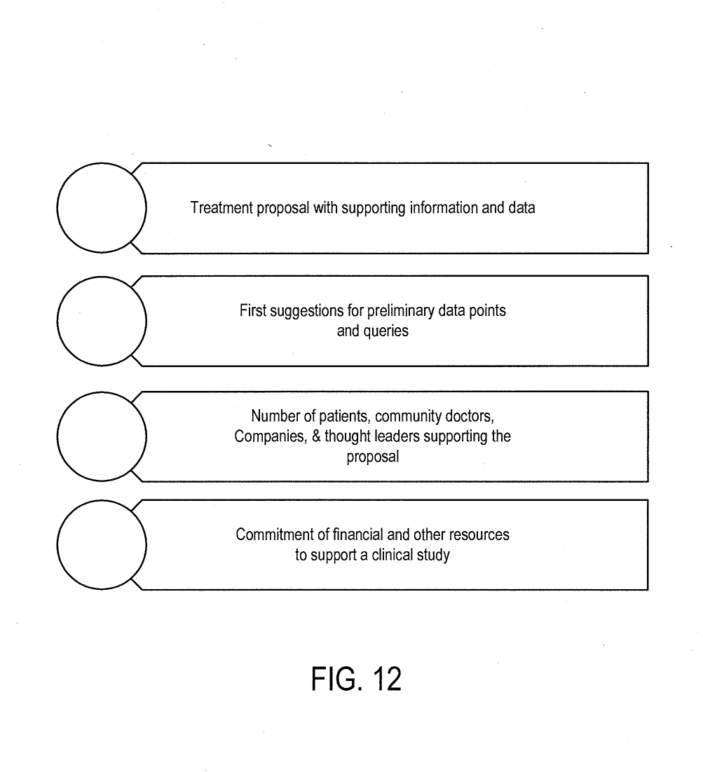

FIGS. 1-6 provide an indication of how each of the entities involved in providing and/or reviewing the information may interact.

Any one of these different entity-types, consumer, mid-level expert, domain expert, third-party Company, can begin an actionable proposal for study and data collection. Each entity-type may be verified using available database approaches to authenticate unique consumers (patients), common field experts (community physicians) and thought leaders (academic physicians). The criteria for being given access or participating in the information exchange may be different for each entity-type. Different entity-types may be thought of as being different levels. Regardless of level a complete proposal for a study using the systems and method herein described, and the network of entities that is created, includes references, rationale, and documentation which other entity-types may be able to edit, corroborate, or refute. Such editing, corroboration and/or refuting may be performed in a manner similar to online encyclopedia management. The editing, corroboration and/or refuting also using allowing for the incorporation and inclusion of data and observation from the field. The information and/or study may be implemented as a prospective study for which the data results would again be incorporated. Participants in studies facilitated by the presently disclosed system may have their information included in one or more databases. Such information may include:
a. Age
b. Gender
c. Race
d. Medications taken
e. Height
f. Weight
g. Major medical conditions

No matter how the data is first entered the following is the basic information that may be documented:
a. Patient or Doctor identifying information
b. Therapy or treatment of interest suggested by Doctor or Patient
c. Relevant data and supporting documentation for the proposed treatment or therapy approach.
d. An initial statement or query of what the kind of additional data would be most helpful to support and document this therapy or treatment.
e. A statement of level of support of the doctor or patient submitting this proposal
   i. Before a proposal can be advanced the user whether a doctor or patient must be willing to commit to participate in a study if one were set-up on the therapy in question so long as he/she is able
   ii. State the financial commitment level they would provide if a study were indeed established for this therapy or treatment

In some implementations, a proposal may be validated through a peer review system. The proposal for a study may be kept private. Access to the study information and/or materials may be limited to those members of the community, facilitated through the presently disclosed system, who are privately invited to comment and review. Additional information that may be provided by members of the community may include:
a. Whether they would participate in a study if it were established for this proposal
b. How much they would financially commit to a study if one were to be set-up for this proposal

Community experts and thought leaders may provide additional information, such as:
a. Medical validity and soundness
b. Likelihood of success
c. Relative importance and impact to healthcare as a whole
d. Other evaluation parameters can be included, but the concept is to get a reasonable assessment of this.

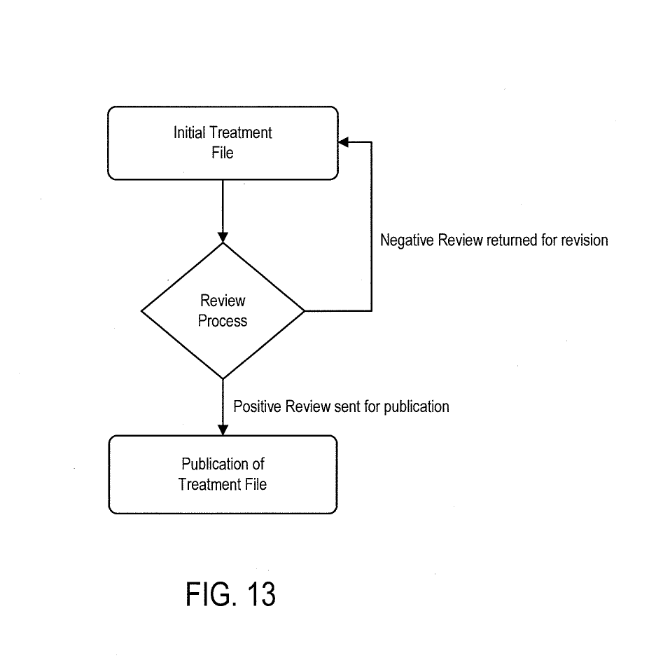

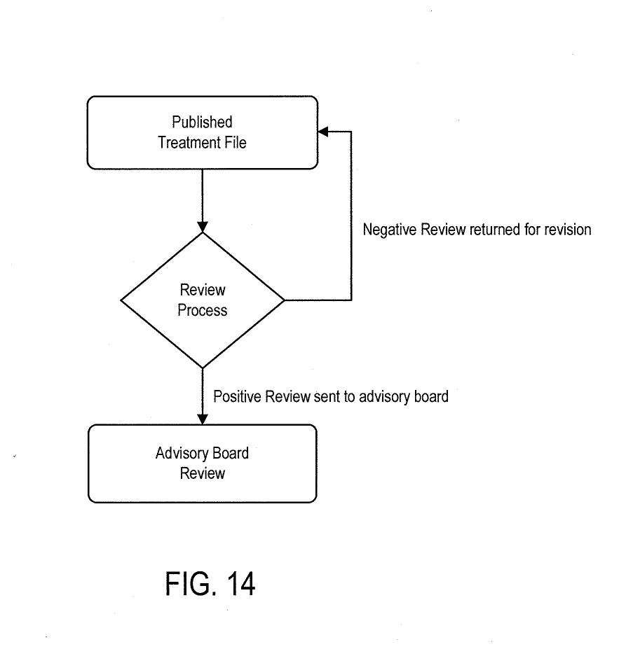

FIG. 13 provides an illustration of the decision tree associated with publishing a treatment plan. An initial proposal may be reviewed. In response to a negative review, the initial proposal may be updated. The proposed treatment plan may be reviewed again at a higher level. In response to a negative review, modifications may be made to the proposed treatment plan. In response to a positive review, the treatment plan may be sent to an advisory board for review. The advisory board may include domain experts. FIG. 14 provides an illustration of the decision tree associated the advisory board determination.

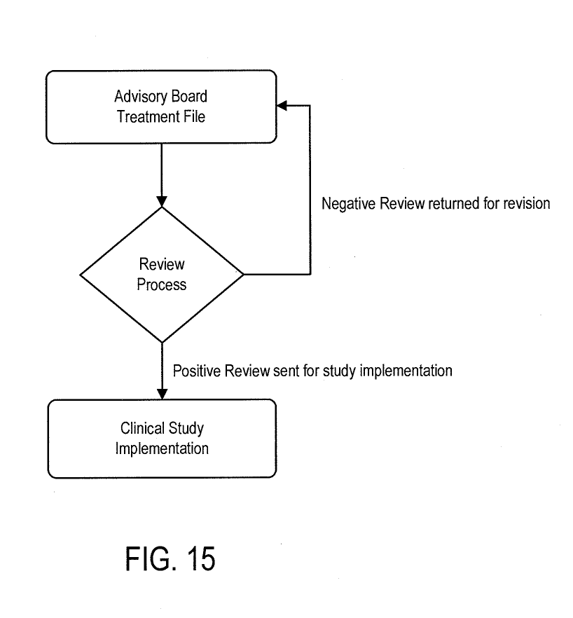

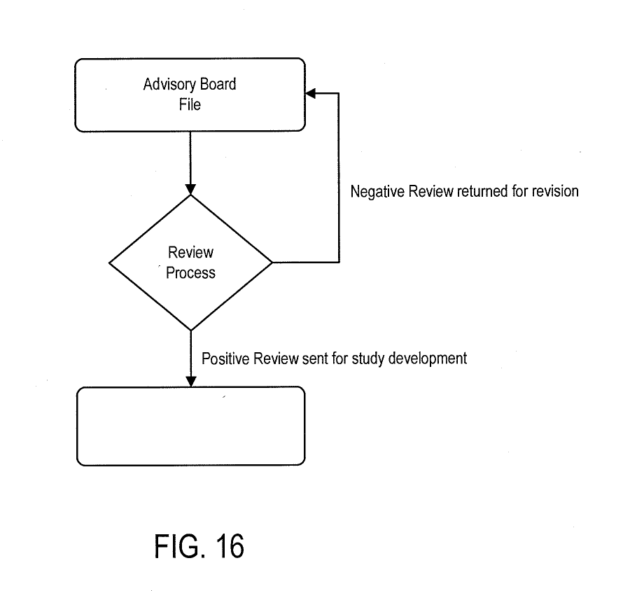

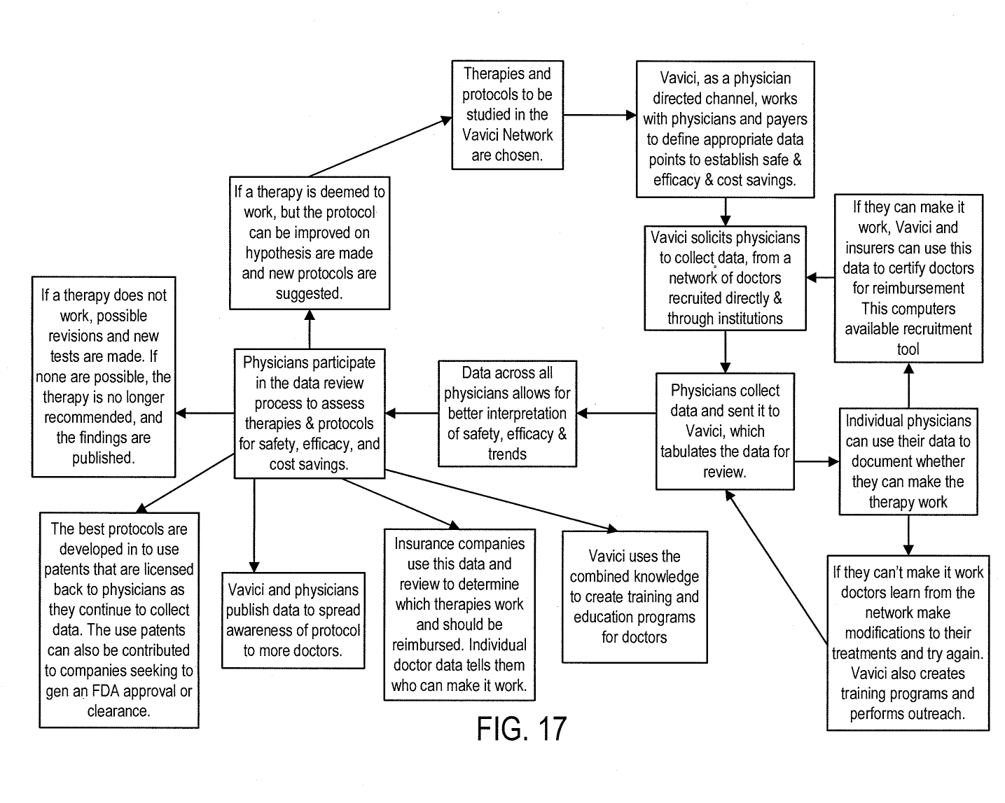

FIG. 15 is an illustration showing the decision tree in response to a review by the advisory board. In response to a favorable review by the systems reviewers, the treatment plan may be sent for implementation into a clinical study. In some implementation, as shown in FIG. 16, the study may require to be developed after the systems reviewer has provided a positive review.

In The one or more system reviewers may review the proposed study for the following combination of events:
a. A large number of patients endorse the proposal. We believe this number to be 10, but it may be changed later.

b. A critical number of community experts (physicians) who have been qualified as such endorse the proposal. We believe this number to be 2
c. A single qualified academic physician endorses the proposal
d. A critical amount of money has been committed. We currently believe this number to be $10,000

Once a system reviewer has reviewed the proposal and documented that it is valid and appropriately documented the proposed study may be published to the community at large. Publishing the study may permit registered users to evaluate the proposal and to update and include information on the proposal. Such updating may be performed using a collaborative updating process such as that used by online encyclopedias. In addition to posting the proposal an initial request for additional supporting data may be implemented. The system 2000 may be configured to publish a simple form for the collection of basic information. For example, if the proposal is that therapy X causes Y clinical event. Patients will be able to enter if they tried X and whether Y clinical event occurred for them. They can then have their physician validate that Y clinical event occurred by sending this to their physician for validation. Physicians who are participating will have a portal that has a place where such reviews take place. They may elect to have a nurse or office manager confirm these findings for them. Data entered are stripped of identifying information and reported on the web site. There may or may not be an intervening review by system reviewers before this data is published. However, when it is published there will be separate columns that show all Data vs all Data that has been physician validated.

Once an agreed number of endorsement and data is supplied, the proposal may be provided to a committee of advisors composed of key thought leaders from top academic institutions. The system may perform all of these steps automatically. These thought leaders may evaluate the data provided and review each proposal based on criteria that will include but not be limited to:
a. Number of patient endorsements
b. Number of community physician endorsement
c. Number of academic physician endorsements
d. Total financial commitment
e. Validity and viability of therapy based on available data and references
f. Potential medical impact of therapy

Certain rules may be in place to determine when a proposed trial is implemented and when one is not. In some implementations, a trial is implemented in response to a critical number of advisors agreeing to implement the trial. Other rules may require one of the advisors to serve as a lead investigator for the trial. Once any and all rules have been adhered to, a formal study may be generated and randomization and clinical data points will be set-up. Typically, this treatment study will differ from a traditional study in that:
a. Instead of thousands of patients and dozens of doctors the study will be opened to millions of patients and thousands of doctors.
b. Randomization may occur through whole institutions instead of by patients to a clinic
c. Data collection will be limited to the minimally useful data set required to establish if there is likely to be efficacy
d. All comers will be permitted so that exclusion criteria will be limited or nonexistent.
e. Patients who agree to be part of the study will sign appropriate documents confirming access by our system to their electronic records
f. In addition to prospective studies, physicians and patients can also provide retrospective data that can be obtained from their records.

This social media generated study approach both creates a massive crowd sourcing and funding of studies, but also links patients to community physicians and ultimately academic physicians creating a community chain that also becomes a validating distribution channel.

It does this by generating peer reviewed physician data across multiple practices. The data documents that a therapy works and the physicians who are using the therapy demonstrate that doctors are willing to use this therapy. This then lowers the risk of development for potential investors.

The system builds upon two legitimate practices that permit the education and usage of non-FDA approved therapies.

First, physicians can legitimately prescribe and utilize non-FDA approved therapies provided the product is legally on the market, there is sufficient medical justification and they are responsible about doing so.

Second, physicians can educate other physicians about non-approved uses for therapies that are available on the market (whether they are FDA approved or cleared by some other means to be on the market).

The system's database creates a safe way for physicians to explore non-FDA approved therapies, by carefully documenting what physicians are doing and by using this data to help confirm safety and efficacy.

The data collected by an individual doctor is not typically sufficient to make convincing assessments, however, when multiple practices are involved and larger patient numbers; safety, efficacy and cost savings can be better documented.

The data can provide useful insights into therapies that are worthy for further development

The data obtained in this fashion while as controlled as traditional clinical studies can set the framework for a traditional clinical study or the FDA may consider that this methodology is statistically more meaningful, because it demonstrates signal from an all-comers population that is not overly controlled as is typically the case in a clinical study. In other words many studies are so well controlled that the data cannot be extrapolated to real patients and physicians. In this case the data is already tested in typical patient settings.

The system can interface with doctors to establish a data collection process that allows them to document their own results and to participate in a larger network of physicians with similar data to form communities that can reach appropriate recommendations on these therapies.

When performed by the presently discloses system, the data collection, analysis and treatment trials are typically unconnected with medical treatment manufacturers. The system is a third party who is independent from such entities; this is in an attempt to eliminate the potential for undue bias. Undue bias can often be found in typical clinical trials. The system is a separate entity from each of the company's products. The system is configured to find products that work and any single product will only be promoted if it can be found to work. The system, as the distributor, benefits from the sale of product, but has a bias only towards finding and carrying the best products and for getting rid of products that don't work as quickly as possible.

During and after completion of a study data is typically reviewed where thought leaders and community physicians discuss the initial findings and may suggest new studies and modifications to improve the protocol. The system itself may identify trends or patterns and use those trends or patens to generate suggestions for new treatments for conditions, and/or modify current treatment plans.

The benefits of physician participation include, but are not limited to:
a. The ability to provide new innovative curative and preventative therapies to patients.
b. Providing physicians with a safer mechanism to explore such therapies, by documenting their results and allowing them to participate in a larger database that will permit better safety and efficacy assessments.
c. By documenting for physicians that they can successfully utilize a given therapy and demonstrate their success rate for insurer reimbursement.
d. By permitting these doctors to become part of a larger community of physicians working together to develop new alternative therapies for patients including curative and wellness treatments.
e. By giving these physicians access to new therapies and protocols as they become available and advising them of safety issues as soon as they are identified.

The physicians or product suppliers may be asked to participate in a review process to openly discuss the results and to decide for themselves if a treatment works and what the best protocols and therapies are.

Those physicians with better results will be able to provide insights and education to those physicians who do not have the same quality results. The combined information about proper usage will form the basis of a training manual and certification process that the system will offer as an additional service.

In addition the data will provide physicians with testable hypotheses to further improve the protocols, which can then be the basis of an additional study and additional patents. This creates a cycle, which improves the therapies as more and more data is collected with each cycle. The process then becomes a dynamic feedback loop.

Insurers use this information to determine which therapies work and which caregivers know how to use them properly. This creates further incentives for physicians to participate in the network and for them to ask for and receive training and certification from the system.

In some cases, insurers will partner with the system to cover the costs of a study and education to physicians related to the study. When the therapy is documented to save costs and money the system may be paid by insurers to provide ongoing education and training to doctors it wishes to utilize these therapies. Currently most patents have no means to legitimately train their doctors in non-FDA approved applications.

Where possible, the system will negotiate for a share of the savings generated from the therapies and protocols and use the data loop to document what the savings are.

When a new therapy uses a device or product, the system will negotiate for a distribution fee every time one of its network physicians use the product or device. The following are examples of devices and products and how this might work:
a. The system documents that a device can be used to treat hypothyroidism. Physicians who wish to participate need to buy the device. The system earns a distribution fee for each device sold to one of its physicians.
b. The system documents that a supplement can be used to more safely treat a patient. Physicians that participate in the study and prescribe the product for their patients generate revenue for the company. The system earns a distribution fee for sales of the product and can document that it has been purchased through the data that is collected.

In addition to documenting new curative and wellness solutions, the network feedback loop permits the safe assessment and evaluation of other treatments on the market. These can include marketed products in their approved indication, but for which there is a question as to whether the products truly work and are safe. Insurers may be willing to pay the system to study these indications for them.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT), a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A computer implemented method performed using one or more physical computer processors, comprising:
receiving, by the one or more physical computer processors, over a computer network information that includes a condition of an entity, the condition associated with a particular domain, and one or more symptoms of the condition experienced by the entity;
providing access to the information, over the computer network, to one or more domain experts; and,
facilitating the provision, by the one or more domain experts, of one or more treatments for the condition.

2. The method of claim 1 where the method further comprises:
tracking the one or more treatments for the condition; and,
analyzing the one or more treatments for its efficacy at treating the condition.

3. The method of claim 1, where facilitating the provision of treatments for the condition by the one or more domain experts includes facilitating the determination of one or more treatments for the condition by the one or more domain experts.

4. The method of claim 1, where the entity includes a human being and the condition is a health condition of the human being, and where the domain experts are medical professionals.

5. The method of claim 2, where analyzing the one or more treatments includes determining the existence of one or more side effects to the treatments experienced by the entity.

6. The method of claim 2, where the method further comprises:
determining, by the one or more physical computer processors, correlations between the one or more created treatments for the condition and the one or more symptoms association with the condition.

7. The method of claim 6, where the method further comprises:
accessing information associated with other conditions, the information including symptom information of the other conditions; and,
generating, by the one or more physical computer processors, a suggestion of treatments for the other conditions based on the correlations determined between the one or more created treatments and the one or more symptoms.

8. The method of claim 1 wherein the information that includes a condition of an entity is received through crowd sourcing.

9. The method of claim 1, wherein the computer network is the Internet.

10. The method of claim 1, wherein the information that includes a condition of an entity is received from one or more treatment providers.

11. The method of claim 1, wherein the information that includes a condition of an entity is received from a financial entity associated with the treatment process.

12. The method of claim 1, further comprising:
filtering the received information, by the one or more physical computer processors, to remove non-salient data from the received information.

13. The method of claim 2, further comprising:
validating the treatments of the condition of the entity based on the analysis of the efficacy of the treatments.

14. The method of claim 13, further comprising:
generating a notification for delivery to domain experts of the validated treatment.

15. The method of claim 13, further comprising:
generating a web-accessible information page, by the one or more physical processors, providing an indication of at least, the validated treatments, associated conditions, associated symptoms, or associated side effects.
